(19) United States
(12) Patent Application Publication
(10) Pub. No.: US 2024/0362066 A1
(43) Pub. Date: Oct. 31, 2024

(54) Run-Time Configurable Architectures

(71) Applicant: The Regents of the University of California, Oakland, CA (US)

(72) Inventors: Sumeet Singh Nagi, Oakland, CA (US); Dejan Markovic, Los Angeles, CA (US)

(73) Assignee: The Regents of the University of California, Oakland, CA (US)

(21) Appl. No.: 18/291,159

(22) PCT Filed: Jul. 20, 2022
(86) PCT No.: PCT/US2022/073939

§ 371 Date: Jan. 22, 2024

Related U.S. Application Data
(60) Provisional application No. 63/234,047, filed on Aug. 17, 2021.
(60) Provisional application No. 63/223,787, filed on Jul. 20, 2021.

(51) Int. Cl. G06F 9/50

(52) U.S. Cl. CPC G06F 9/5027

(57) ABSTRACT

Systems and method for scheduler architectures that can enable reconfigurable architecture to execute multiple functions in accordance with embodiments of the invention are described. An embodiment includes a compiler system for reconfiguration of compute resources, including: a scheduler, a reconfigurable architecture array including several a hardware resources, where the schedular dynamically reconfigures the reconfigurable architecture array by: determining several programs including a first program and a second program that require execution on the reconfigurable architecture array at a particular time n, wherein each program includes several function, and determining hardware resources required by the first program and the second program; allocate a set of functions from the several functions of the first program and the second program to different hardware resources from the several hardware resources of the reconfigurable architecture array based on the determined hardware resources required by the first program and the second program.

### CROSS-REFERENCE TO RELATED APPLICATIONS

This application claims benefit of and priority under 35 U.S.C. 119(e) to U.S. Provisional Patent Application No. 63/223,787 filed on Jul. 20, 2021, titled “Run-Time Reconfigurable Architecture” by Nagi et al., and to U.S. Provisional Patent Application No. 63/234,047 filed on Aug. 17, 2021, titled “Run-Time Configurable Architectures” by Nagi et al., the disclosures of which are hereby incorporated by reference in their entirety for all purposes.

### GOVERNMENT SUPPORT CLAUSE

This invention was made with government support under Grant Number N66001-20-C-4001, awarded by the U.S. Department of Defense. The government has certain rights in the invention.

### FIELD OF THE INVENTION

The present invention generally relates to coarse grain reconfigurable architectures (CGRA), an in particular to scheduler architectures that can enable reconfigurable architecture to execute multiple functions from a single program, multiple programs and/or multiple functions/programs simultaneously, concurrently and/or consecutively spatially and/or temporally.

### BACKGROUND

Advancements in semiconductor technology are responsible for the exponential growth in computing performance and algorithmic development. As the transistor size approaches physical limits, this scaling has now slowed. Conventional general purpose computing architectures, like CPU, are unable to keep up with the increasing requirements of modern algorithms because of their inherent architectural inefficiencies. To address this, industry developed specialized hardware solutions (ASICs or accelerator) for each computational heavy task; a modern system can have up to 30 different ASICs or accelerators. Each such ASIC (stand-alone application-specific chip) or accelerator (custom block inside a system-on-a-chip or SoC) can be designed for a very particular algorithm and can cost up to $100M to design, may take several years to qualify and manufacture, and becomes useless as the algorithm advances and cannot be repurposed. The several years of development can require multiple design iterations and multiple optimizations and tweaks. Conventionally industry uses FPGA for the emulation of ASICs during the design and development and the debugging process, and novel state-of-the-art systems can also be deployed using such FPGA based implementations. These FPGA implementations can be faster and cheaper to develop as compared to developing ASIC, but they have a very limited performance and have low throughput and are extremely power inefficient (˜100× worse) as compared to an ASIC or accelerator. The FPGA based state-of-the-art deployments can have multiple large FPGAs to perform the job of a single ASIC. An FPGA can be 10×-100× worse in performance throughput and area efficiency as compared to an ASIC. Further, FPGAs are “static” and cannot be quickly repurposed.

### SUMMARY OF THE INVENTION

Systems and method for scheduler architectures that can enable reconfigurable architecture to execute multiple functions in accordance with embodiments of the invention are described. An embodiment includes a compiler system for reconfiguration of compute resources, including: a scheduler, a reconfigurable architecture array including several a hardware resources, where the schedular dynamically reconfigures the reconfigurable architecture array by: determining several programs including a first program and a second program that require execution on the reconfigurable architecture array at a particular time n, wherein each program includes several function, and determining hardware resources required by the first program and the second program; allocate a set of functions from the several functions of the first program and the second program to different hardware resources from the several hardware resources of the reconfigurable architecture array based on the determined hardware resources required by the first program and the second program.

In a further embodiment, the compiler system of further includes: using at least one transformation to allocate the set of functions to the different of hardware resources of the plurality of hardware resources of the reconfigurable architecture array.

In a further embodiment again, the at least one transformation is a transformation selected from the group consisting of a translation, an affine transform, a vertical flip, a horizontal flip, and a rotation.

In yet a further embodiment, The compiler system further includes: determining that there is sufficient available hardware resources from the several hardware resources of the reconfigurable architecture array to accommodate the first program and the second program; and allocating the first program and the second program on the reconfigurable architecture array.

In still a further embodiment, the compiler system further includes: determining that there is insufficient available resources from the plurality of resources of the reconfigurable architecture array to accommodate the first program and the second program; and allocating the entire first program and a reduced subset of functions from the plurality of functions of the second program on the reconfigurable architecture array.

In still a further embodiment, the compiler system further includes: determining that a third program requires execution on the reconfigurable architecture array; determining that there is insufficient available resources from the plurality of resources of the reconfigurable architecture array to accommodate the first program, the second program, and the third program; and evicting at least one program from the plurality of programs from the reconfigurable architecture array.

In still a further embodiment again, the compiler system further includes: placing the evicted at least one program on a temporal waitlist; reallocating the evicted at least one program to the reconfigurable architecture array at a later time period n+1.

In still a further embodiment still, the compiler system further includes: determining a priority of each of the plurality of programs; and allocating hardware resources of the reconfigurable architecture array to the plurality of programs based on the priority.

In yet still a further embodiment, the compiler system further includes: randomizing physical locations of the set of functions on the reconfigurable architecture array; and executing a power noisy program (NP) on the reconfigurable architecture array.

In yet still a further embodiment again, the compiler system further includes: detecting a defective hardware resource from the plurality of hardware resources of the reconfigurable architecture array; and allocate the set of functions from the plurality of functions of the first program and the second program to different hardware resources that avoids the defective hardware resource of the reconfigurable architecture array.

In yet a further embodiment again, the compiler system further includes: virtualizing hardware resources of the reconfigurable architecture array over a plurality of programs and a plurality of functions.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram that illustrates a Program 1 and a Program 2 multiplexed on a reconfigurable hardware and their encompassing polygons in accordance with an embodiment of the invention.

FIG. 2 illustrates a Program 1 and a Program 2 multiplexed on a reconfigurable hardware temporally and their encompassing polygons is a in accordance with an embodiment of the invention.

FIG. 3 illustrates a Program 1, Program 2, and Program 3 multiplexed on a reconfigurable hardware spatially and temporally and their encompassing polygons in accordance with an embodiment of the invention.

FIGS. 4A-4B illustrate an example of affine transforms and flipping performed by a schedular, where the transformations include translations, affine transforms, flipping and rotations as well as combinations of transformations to hard map a soft mapping generated by a compiler to a reconfigurable architecture at run-time in accordance with an embodiment of the invention.

FIG. 5 illustrates an example a scheduler accommodating a number of programs and functions where two programs with a same priority try to access the reconfigurable architecture in accordance with an embodiment of the invention.

FIG. 6 illustrates an example where two programs of a same priority access a reconfigurable architecture and execute simultaneously and not enough resources are available to accommodate the new incoming program in accordance with an embodiment of the invention.

FIG. 7 illustrates an example with two programs with different priorities accessing a reconfigurable architecture in accordance with an embodiment of the invention.

FIG. 8 illustrates an example in which all programs have a same priority where a program may need to be evicted in accordance with an embodiment of the invention.

FIG. 9 illustrates programs and functions, where a program can be defined as a set of functions executing simultaneously or consecutively in some order in accordance with some embodiments of the invention.

FIGS. 10A-10B illustrates an example of a large program broken down into its constituent functions to map successfully to a reconfigurable architecture temporally and spatially in accordance with various embodiments of the invention.

FIGS. 11A-11B illustrate an example for security and cybersecurity applications that allow reconfigurable architecture to randomize physical location of program/function on the reconfigurable architecture in accordance with an embodiment of the invention.

FIG. 12 illustrates an example of a scheduler enabling a defect resilient program/function execution on a reconfigurable architecture in accordance with a number of embodiments of the invention.

FIG. 13 illustrates an example a scheduler generating and using some reconfigurable architecture resource utilization descriptive features including a set of anchor points to speed up a process of mapping an incoming program onto the available resources on a reconfigurable architecture in accordance with an embodiment of the invention.

FIG. 14 illustrates a hardware architecture configuration of a scheduler and reconfigurable architecture in accordance with an embodiment of the invention.

### DETAILED DESCRIPTION OF THE DRAWINGS

Turning now to the drawings, systems and methods for coarse grain reconfigurable architectures (CGRA), an in particular to scheduler architectures that can enable reconfigurable architecture to execute multiple functions from a single program, multiple programs and/or multiple functions/programs simultaneously, concurrently and/or consecutively spatially or temporally in accordance with embodiments of the invention are described.

Reconfigurable architectures in accordance with many embodiments provide for a scheduler architecture that can enable a reconfigurable architecture including CGRA, compute arrays, FPGA, DSP FPGA, DSP, among various other architectures. Reconfigurable architectures in accordance with many embodiments can execute a) multiple functions from a single program, b) multiple programs (planned or unplanned to co-run together) and/or c) multiple functions/programs from different hosts and/or connected devices over a network and/or over the Internet, simultaneously, concurrently and/or consecutively spatially or temporally. Reconfigurable architectures in accordance with many embodiments can include decisions to multiplex one or more programs that can be based on different conditions including run-time dynamics, unplanned program conditions, interrupts, pre-planned and/or pre-compiled conditions, and also include resource utilizations of the configurable architecture and/or priorities of the programs.

Current CGRA based solutions can be divided into two broad categories, 1) dynamically run-time compiled CGRA solutions or 2) static pre-compiled CGRA solutions. In a dynamically run-time compiled solution, a CGRA is given a simple set of instructions and arithmetic, and the CGRA then combines those instructions/arithmetic into a single multi-arithmetic instruction at run-time and executes them on its processing element array. For a pre-compiled CGRA solution, the program that needs to be computed is already compiled for. The program and its functions are already planned out spatially and temporally, so that at run-time the entire program and the configuration bits are directly copied over to the CGRA and the program is executed.

In a real world situation, it may not have the luxury of executing a single program at a time on the CGRA, and also planning out the sequence of functions and programs at the compilation time can be difficult. A dynamic run-time compiled CGRA can be better able to handle multi-program/multi-function tasks since it can dynamically re-allocate its resources and adjust the program to fit the available resources. However, since the overhead of run-time compile can be large and since only a limited set of instructions may be compiled at a time, it can be difficult to generate a resource efficient and performance optimal solution. On the other hand a static pre-compiled CGRA solution can be more optimal and efficient in its program execution, since a compiler can generate and optimize the CGRA program during the compile time and generate a single efficient compiled solution. On the other hand, the pre-compiled CGRA solutions can run into run-time conflicts and bottlenecks, as when a single program/function is executing on the reconfigurable architecture, no other program and/or function can be executed at the same time. Thus a pre compiled solution although efficient can be very inflexible to the run-time dynamics of a multi-program multi-function execution.

Many prior art solutions can require a detailed input for the program from the user, and they can be limiting in run-time reconfigurability. Accordingly, reconfigurable architectures in accordance with many embodiments provide for the support of multiple loadable accelerators with easy relocations and reconfiguration. Reconfigurable architectures in accordance with many embodiments provide platform/architecture agnostic partial reconfiguration techniques that can be widely adopted across multiple generations and revisions of reconfigurable architectures. Reconfigurable architectures in accordance with many embodiments, at the management level, provide for improved abstraction to allow loading and unloading of new configurations similar to software modules. Many embodiments of the reconfigurable architectures provide frameworks and applications that can automatically generate partial reconfigurable implementable solutions. Reconfigurable architectures in accordance with many embodiments can provide frameworks that can have end-to-end support for many of the different processes and features that may be needed for partial reconfiguration implementation requiring minimal intervention from a designer. Reconfigurable architectures in accordance with many embodiments provide frameworks that can be able to automatically abstract out the hardware aspects of an implementation from the high level descriptions provided by a user.

### System Overview

Reconfigurable architectures in accordance with many embodiments of the invention can reduce inefficiencies of run-time compiled reconfigurable architectures and address the poor flexibility of static pre-compiled reconfigurable architectures. Reconfigurable architectures in accordance with many embodiments provide for solutions which in an abstract way lie somewhere in between a completely run-time compiled solution and an entirely pre-compiled solution. Reconfigurable architectures in accordance with many embodiments include a scheduler that can mediate between a host and a reconfigurable architecture array. Reconfigurable architectures in accordance with many embodiments provide various processes for compiling and programming the resources of the reconfigurable architecture, and a paradigm on how programs can be compiled for such reconfigurable architectures. Reconfigurable architectures in accordance with many embodiments can be implemented using a Field Programmable Gate Array, a Coarse Grain Reconfigurable Architecture, a Compute Array, a Digital Signal Processor array, among various other types of architectures as appropriate to the requirements of specific applications in accordance with various embodiments of the invention.

Reconfigurable architectures in accordance with many embodiments include hardware whose computational characteristics can be controlled and/or modified by some bits and/or programs. Reconfigurable architectures in accordance with several embodiments can include logic elements, a networking interconnect layer and control elements. The logic elements can include resources including compute elements, including multipliers, dividers, adders among others, bitwise operands, including XOR, NOR, NAND, AND, OR, INV, Flip-flops, Latches, Multiplexers among others, Look Up Tables (LUTs), Configurable Logic Blocks (CLBs), storage (including Buffers, Registers, SRAM, Register Files among others) and/or any combination of the aforementioned objects. Reconfigurable architectures in accordance with many embodiments can be implemented on different kinds of architectures and the use of a reconfigurable architecture with some degree of regularity and symmetry (e.g., where a symmetry can be of different forms including of axial symmetry, point of symmetry, line of symmetry, even and/or odd symmetry, mirror symmetry, among others) irrespective of homogeneity or heterogeneity in its elements, can have the potential to speed up the run-time mapping and compilation by a scheduler. In many embodiments of the reconfigurable architecture, a networking layer can facilitate communication between logic elements, external sources, internal sources, and/or control elements. A control element can use bits and/or configuration bits to modify the other elements of the reconfigurable architectures in accordance with many embodiments of the invention.

Reconfigurable architectures in accordance with many embodiments of the invention can use existing control elements and provide the control elements extra features thus making them intelligent to efficiently utilize and optimize a reconfigurable architecture for a variety of scenarios. Reconfigurable architectures can be used for optimizing multiple programs, multiple functions, multiple hosts and/or multiple connected devices over a network and/or over the internet, multiple secondary devices including of GPU, FPGA, CGRA, compute array among others, a program with resource utilization larger than resources available on a reconfigurable architecture, and/or a program with resource utilization smaller than resources available on reconfigurable architecture, among various other scenarios as appropriate to the requirements of specific applications in accordance with embodiments of the invention.

Reconfigurable architectures in accordance with many embodiments can provide one or more processes for compiling a program for the reconfigurable architecture (e.g., FPGA, CGRA, compute arrays among others) which can broadly be broken down into the following processes.

### Compilers

Reconfigurable architectures in accordance with many embodiments can include a compiler that can follow user directives and/or intelligently self-compile a given program into a program which can be executed partially on the host (e.g., which would the computing resource issuing instructions to the reconfigurable architecture or requesting hardware access to the reconfigurable architecture, such a computing resource can include of a CPU, GPU, Server, an FPGA, CGRA, DSP, some resource over the network or Internet or some other computing architecture), and partially on the reconfigurable architecture, and/or entirely on reconfigurable architecture, and/or a mix of all the available hardware elements.

Reconfigurable architectures in accordance with many embodiments include a compiler that can generate a soft-mapped partially compiled program and generate its configuration bits from a provided program by a user and/or some host compute resource. In many embodiments, this partially compiled program can include the information which could include the functional units, the configuration of the functional units compute resources, the configuration of the compute resources, and routing that may be needed by the program and their configurations in a form of soft-mapping, the size of the mapping, a polygon or polygons which encompasses the mapping, and additional information about the shape of polygon, its origin, and/or its orientation and information which could be helpful for a scheduler to run-time map the soft mapping on to the functional units and routing network on the reconfigurable architecture.

In many embodiments of the reconfigurable architectures, a size of a polygon can be adjusted (e.g., it could be 4-sided polygon, 5-sided, 10-sided, or any n-sided polygon). The complexity and the order of the polygon can affect the number of computations required by a scheduler at run-time. A lower order polygon can be chosen to make the run-time configuration by a scheduler faster but may cause some mapping inefficiencies and vacant resources in a reconfigurable architecture, while a higher order polygon might require more computations at run-time by a scheduler to fit the polygon onto available resources on a reconfigurable architecture. For the highest order polygon for any given soft mapping it would be equivalent to placing each soft mapped abstract resource of the program to the reconfigurable architecture independently and may require recompiling the interconnect network between those resources. The smaller order polygon may function close to a static pre-compiled reconfigurable architecture solution but much more flexible while also allowing spatial and temporal multiplexing, while a higher order polygon and a flexible routing solution would function closer to a dynamically run-time compiled solution.

Reconfigurable architectures in accordance with many embodiments can include schedulers that enable the reconfigurable architecture to operate in a vast range of flexibilities and efficiencies and a user can choose an order optimal for their solution. Reconfigurable architectures in accordance with many embodiments can include a compiler that in addition to a polygon, the compiler can also add various other metadata objects, including an origin of the polygon, an orientation of the polygon, and other geometric properties of the polygon and encompassed functional units. A hardware scheduler can utilize this information, including the geometric properties of the polygon, the function and/or the program to map the program to a reconfigurable architecture.

In many embodiments of the reconfigurable architectures, a compiler generates multiple such reconfigurable architecture executable solutions for a single program. The compiler can utilize various different graph and compute morphing techniques to generate a multi-size compile solution. The multi-size compiled solution can have a solution which maps to the entirety of a reconfigurable architecture, a certain percentage of the architecture (e.g., such as 90% of a reconfigurable architecture, 50% of a reconfigurable architecture or any range between 0%-100% of a reconfigurable architecture). A 0% solution can mean that a program may not use any resources on a reconfigurable architecture and is unable to be run on the reconfigurable architecture, a 1% solution can mean that the program only utilizes 1% of all the resources of a reconfigurable architecture, while a 100% compiled solution can mean that the program uses 100% of the resources of a reconfigurable architecture. Reconfigurable architectures in accordance with many embodiments can include a compiler that can generate any number of solutions based on different possible permutations and combinations from graph and compute morphing techniques and multi-size compiler methods. The higher the number of these solutions can mean larger amount of storage for the program, but also increased mappability on a reconfigurable architecture hardware. A lower number of such multi-size compiled solutions may reduce the amount of storage required for the program, but it might decrease the mappability of the program on a reconfigurable architecture. A compiler can make the choice of a reconfigurable architecture occupancy range and the number of multi-sized compiled solutions for the program on its own and/or the user can direct the compiler to fix the aforementioned numbers, based on some usage and occupancy data for a reconfigurable architecture.

Reconfigurable architectures in accordance with many embodiments can include a compiler that can also assign each program a priority number, and this assignment may be dictated by an importance of the program, and/or its performance requirements such as throughput, latency among various other requirements. A user can also define and assign a priority number to each program. A priority number can be used by a scheduler, as described in detail below, to resolve some multi-program and/or resource conflicts and may also help a scheduler to assign a temporal multiplexing routine to the programs.

### Schedulers

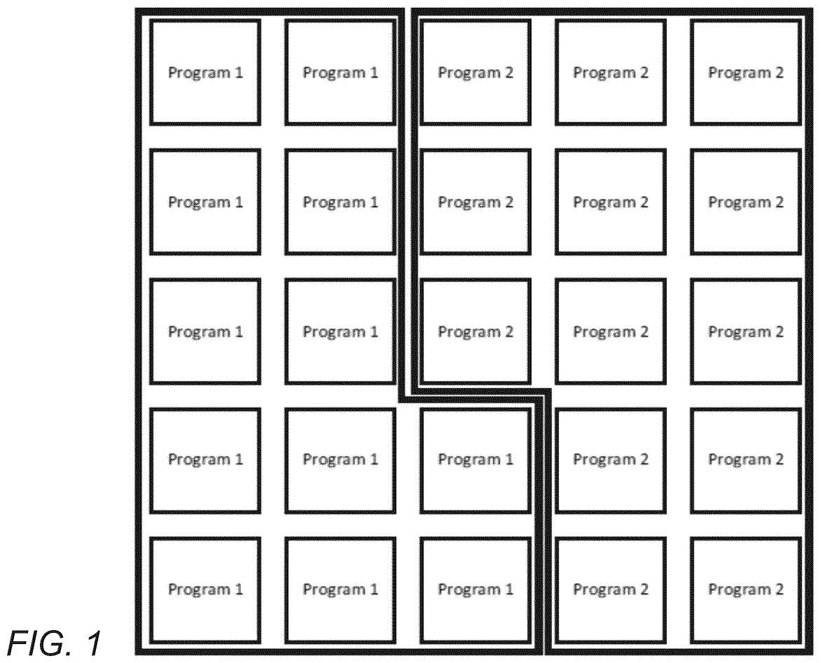

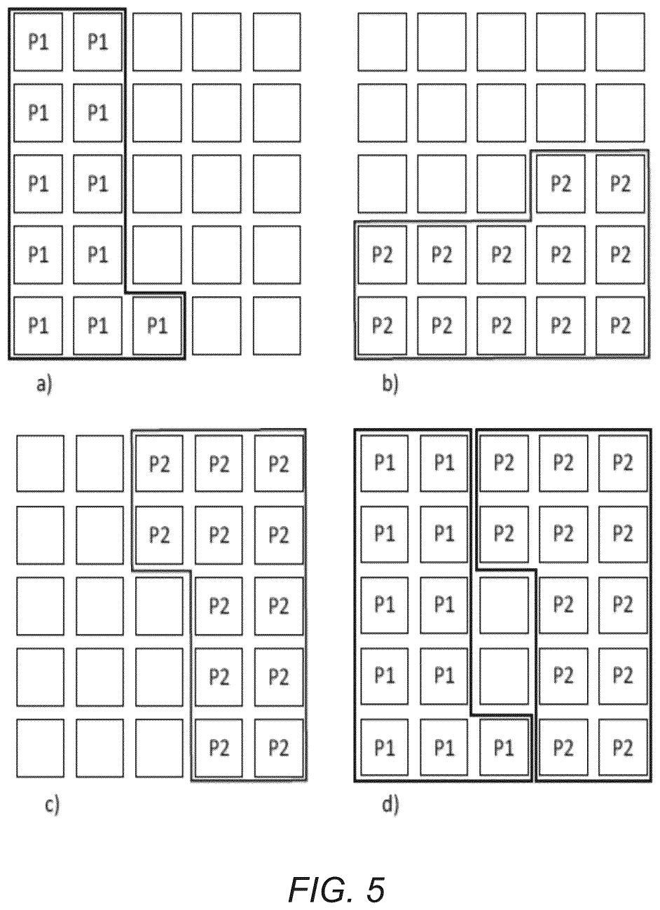

Reconfigurable architectures in accordance with many embodiments can include a scheduler that manages one or more programs being executed on the reconfigurable architecture. A scheduler can intermediate between a host (e.g., which can be a CPU, some external compute engine, an FPGA, GPU, memory, a compute resources over the internet, among various other resources) and the reconfigurable architecture. Reconfigurable architectures in accordance with many embodiments, a host can request to a scheduler to execute a program on the reconfigurable architecture, and can send a soft mapped program, metadata, and/or encompassing polygon information. Reconfigurable architectures in accordance with many embodiments, a scheduler can manage the resources of the reconfigurable architecture and track the resources currently being utilized on the reconfigurable architecture by current programs, functions and/or by other program and/or functions in the temporal routine. In many embodiments of the reconfigurable architectures, by using the information of currently utilized resources and the resources requested by an incoming program, a scheduler can try to map an incoming program onto the reconfigurable architecture. During a transition of trying to map the incoming program, several outcomes can include a scheduler may be able to successfully map an incoming program onto a reconfigurable architecture, as illustrated in FIG. 1 and FIG. 5 in accordance with an embodiment of the invention. A scheduler in accordance with many embodiments of the reconfigurable architectures may be unable to successfully map an incoming program onto a reconfigurable architecture. In many embodiments, if the scheduler is unable to map a program onto a reconfigurable architecture, it can search for various other solutions enabled by processes described herein.

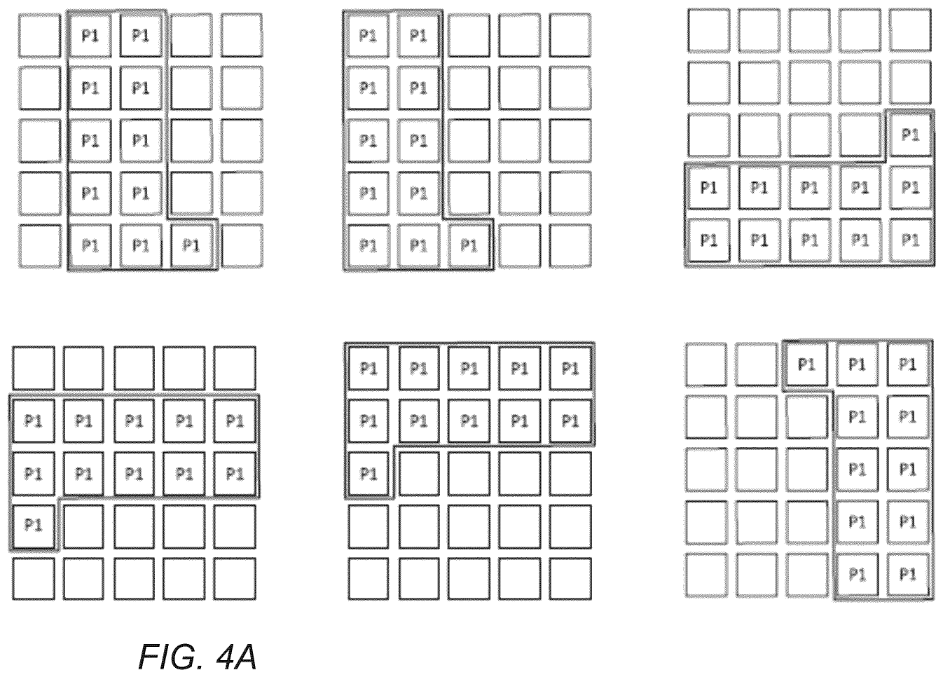

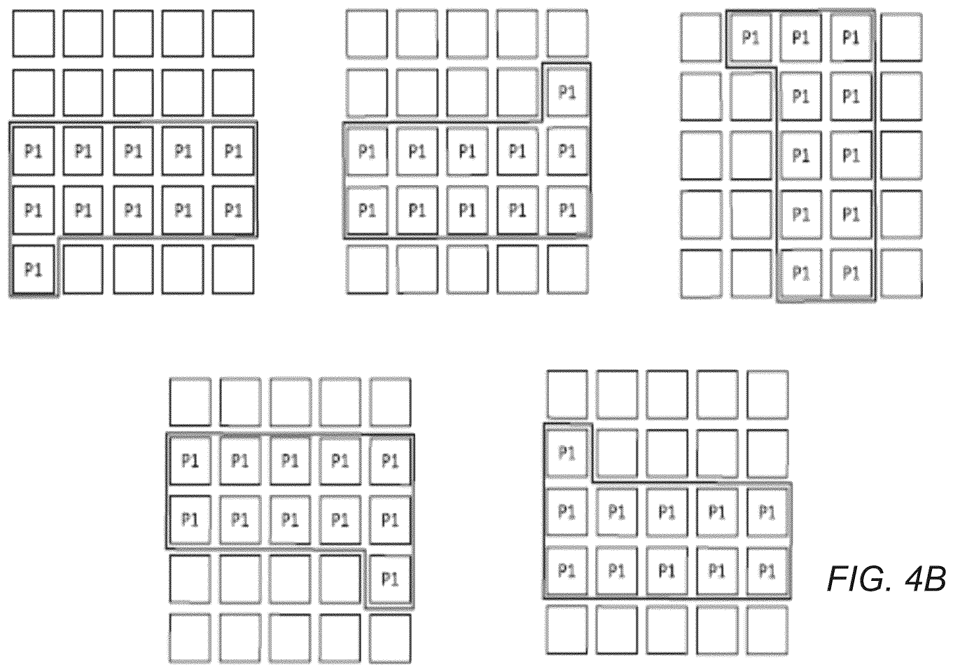

Reconfigurable architectures in accordance with many embodiments provide for situations, including if a prior program or programs requested access for the reconfigurable architecture that is currently still utilizing the reconfigurable architecture, a scheduler can perform some transforms including affine transforms, translations, flipping (e.g., horizontally or vertically) and/or rotations to fit a polygon of a new incoming program on to the available/vacant compute units on the reconfigurable architecture array, as illustrated in FIG. 4A-4B and FIG. 5 in accordance with various embodiments of the invention.

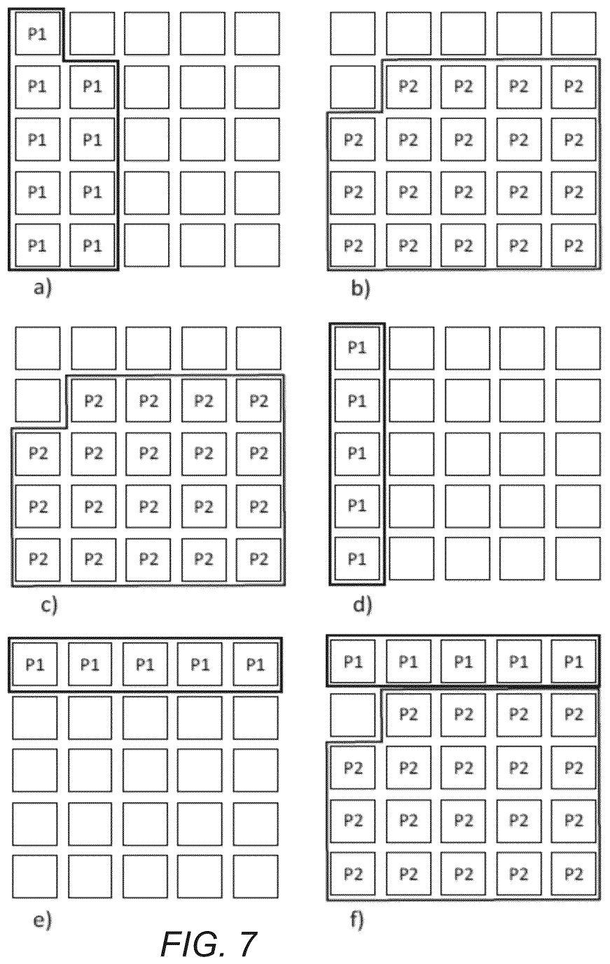

Reconfigurable architectures in accordance with many embodiments provide for situations including if a scheduler is unable to map an incoming program onto the reconfigurable architecture, the schedular can compare the priorities of the programs currently executing on the reconfigurable architecture and the priority of an incoming program, and if the priority of the incoming program is higher than the existing programs on the reconfigurable architecture, the scheduler can evict some program/function currently executing on the reconfigurable architecture to free up resources for the incoming higher priority program. This can successfully map the incoming higher priority program, but may need to re-map the evicted program. In case of a lower priority of the incoming program, the scheduler may fail to map the incoming program onto the reconfigurable architecture in the same time step and may include it in the scheduling for execution when enough resources become available later, as illustrated in FIG. 7 in accordance with various embodiments of the invention.

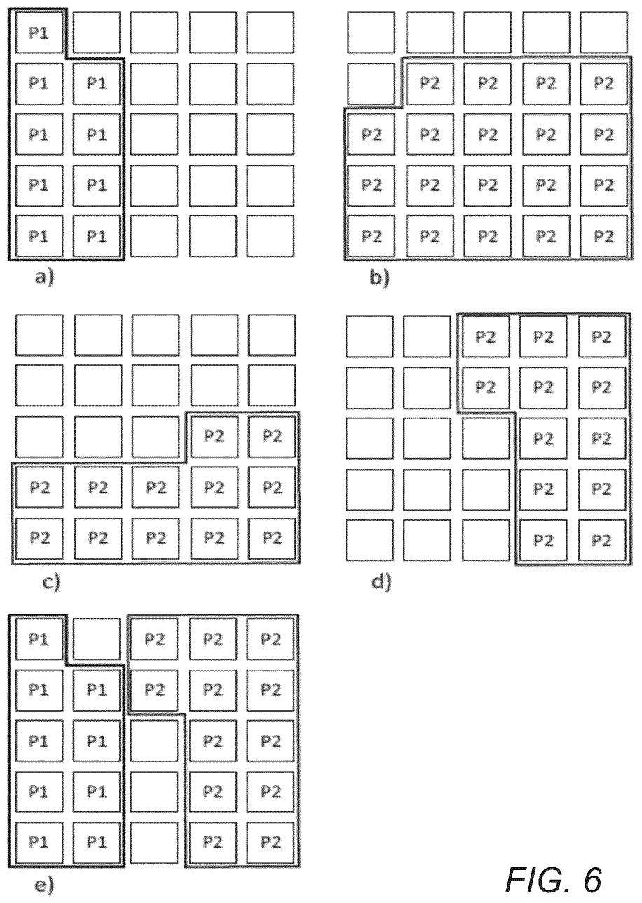

Reconfigurable architectures in accordance with many embodiments provide for situations including if a scheduler is unable to map an incoming program on to the reconfigurable architecture, the scheduler may compare the priority/priorities of the program/programs currently executing on the reconfigurable architecture and the priority of the incoming program. If the priorities of the programs involved are the same and/or similar, then a scheduler may request the program with the least priority and/or some intelligent scheduling metric to reduce its footprint of resources on the reconfigurable architecture. Reconfigurable architectures in accordance with many embodiments may use different processes and methods for reducing footprint of resources which can be enabled by multi-size compile techniques. Reconfigurable architectures in accordance with many embodiments provide for a reduced footprint and resource utilization of resources which can free up some resources for an incoming program (e.g., which could also leverage multi-size compile). In many embodiments of the reconfigurable architectures, a scheduler may try to map an incoming program again. It may either succeeds or fail. In many embodiments of the reconfigurable architectures, if a scheduler fails to successfully map an incoming program on to a reconfigurable architecture, the scheduler can repeat the process of reducing foot prints of the existing programs, currently executing on a reconfigurable architecture as well reducing foot print of a new incoming program, until they all can map together simultaneously onto the reconfigurable architecture, as illustrated in FIG. 6 in accordance with an embodiment of the invention.

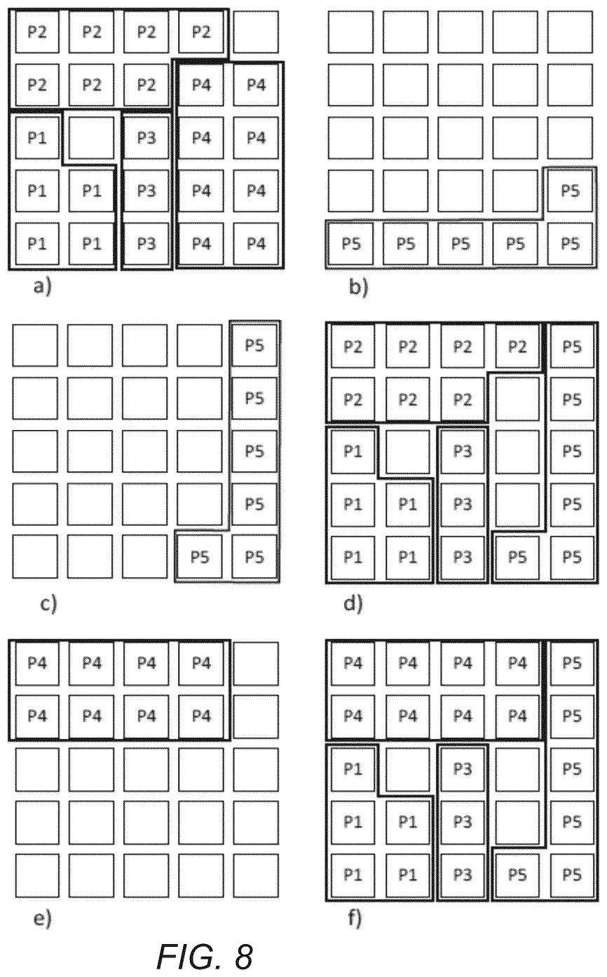

Reconfigurable architectures in accordance with many embodiments provide for a situation if a scheduler is unable to map an incoming program onto a reconfigurable architecture, and all the existing programs on the reconfigurable architecture are of equal or of higher priority than an incoming program, then the scheduler can inform a host and/or a requesting architecture of the developments and the absence of vacancy on the reconfigurable architecture. In many embodiments, a scheduler can also then schedule the incoming/evicted program for a temporal multiplexing. The temporal multiplexing can take into account that the currently executing program/programs may finish at some point, vacating resources for the waiting programs. In many embodiments of the reconfigurable architectures, incoming programs/evicted programs can execute after resources have been freed from the higher priority programs, as illustrated in FIG. 8 in accordance with an embodiment of the invention.

In many embodiments of the reconfigurable architectures, a mechanism can be set up to adjust priorities of waiting programs in a temporal routine, to increase them so that the waiting programs do not have to wait for a long time for the currently executing programs to finish. A mechanism can also be set up to decrease the priorities of certain programs being actively executed on the reconfigurable architecture.

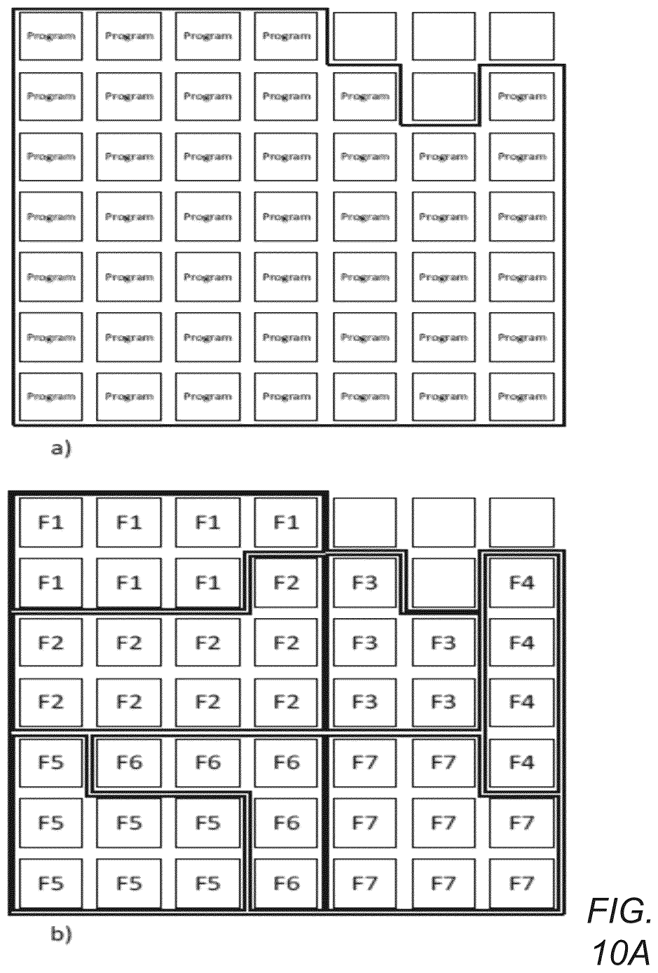

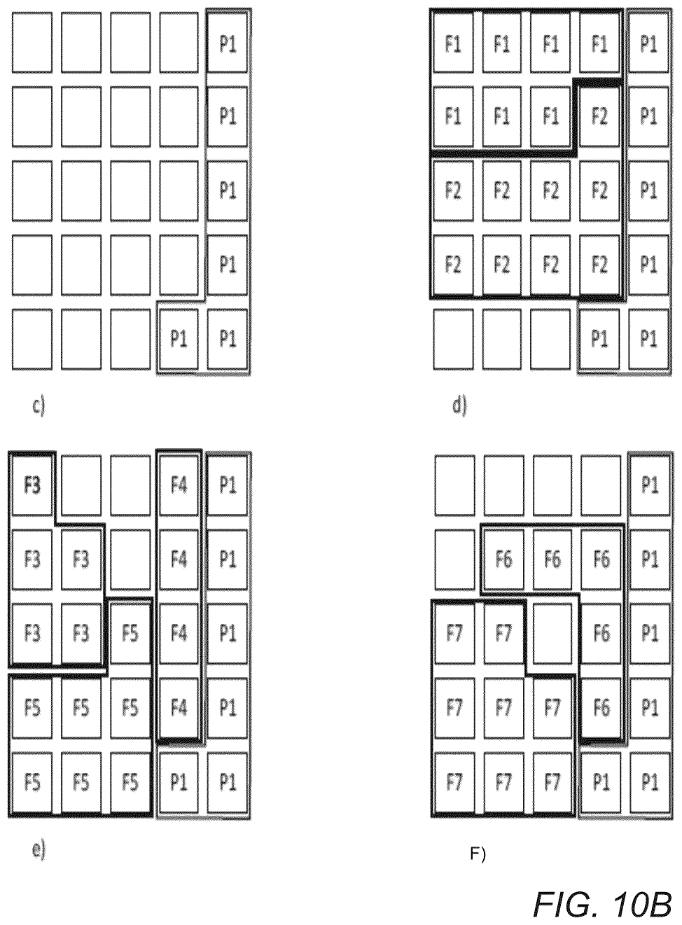

Reconfigurable architectures in accordance with many embodiments provide for situations where there may be a possibility that a requested program is larger than the size of the reconfigurable architecture. Reconfigurable architectures in accordance with many embodiments can use multi-size compile technique and a compiler solution can break down a program into its constituent functions, and the functions can then be executed on the reconfigurable architecture. Each function of a program may behave like a program on the reconfigurable architecture and may go through similar processes as described for programs herein. Reconfigurable architectures in accordance with many embodiments, a function or functions or a subset of functions may be mapped spatial or temporally or be mapped spatially and temporally as illustrated in FIG. 10 in accordance with an embodiment of the invention.

Reconfigurable architectures in accordance with many embodiments can be implemented for a variety of real-world scenarios that include multi-program, multiple-users, multi-function, large program, small program, small function, multiple-hosts (e.g., hosts that include CPU, GPU, FPGA, CGRA, DSP, host connected over network/Internet, among various other hots). Reconfigurable architectures in accordance with many embodiments can dynamically reconfigure for incoming programs/functions without requiring to stop/pause its current execution and computation.

Reconfigurable architectures in accordance with many embodiments can provide security against cyberattacks and to commonly known security issues including, power-aware attacks. For example, reconfigurable architectures in accordance with many embodiments, a scheduler can randomly arbitrate a location of program/function execution at the beginning as well at the run-time and a user can execute a random program or function surrounding their desired function to generate noise on the power rails, which has the potential to interrupt any power-aware attacks or side-channel attacks.

Reconfigurable architectures in accordance with many embodiments provide a potential to increase throughput and reduce latency of a reconfigurable architecture while increasing its flexibility, making it lucrative for various computing scenarios including of Cognitive Radio, Software Defined Radio, Spectrum Sensing, Digital Signal Processing, ASIC replacement, enhancing general purpose compute, Mobile SoC, Desktop SoC, Server SoC, state-of-the-art computing solutions, among various other high-throughput, low-latency, high-flexibility requirement domains and scenarios.

Reconfigurable architectures in accordance with many embodiments provide for the quick loading and offloading of programs and functions that can be enabled, providing a solution for multiple adaptive algorithms that include various examples including data driven processing algorithms, software defined radios, data processing servers, graph computing, machine learning, 6G, among others. Reconfigurable architectures in accordance with many embodiments can increase hardware utilization of a reconfigurable architecture by allocating resources available on the reconfigurable architecture to multiple programs, multiple functions, multiple hosts and more spatially as well as temporally.

Reconfigurable architectures in accordance with many embodiments can monitor, control and/or optimize program and function execution strategy without requiring external intervention, which can potentially do the management, control and optimizations independently.

Reconfigurable architectures in accordance with many embodiments can enable the reconfigurable architecture to be scalable. Reconfigurable architectures in accordance with many embodiments can separate the abstract of computing granularity from the granularity of the reconfigurable architecture and multi-size compile. Conventional approaches may be unable to do so and their complexity increases as the size of reconfigurable architecture increases. This separation of granularity of computation and reconfigurable architecture can allow for the reconfigurable architectures in accordance with many embodiments to be scalable, and can adjust a size of granularity of computation in proportion with the granularity of the reconfigurable architecture which can allow it to decrease or increase the amount of computation and overhead required to achieve fast and low latency run-time reconfigurability.

Reconfigurable architectures in accordance with many embodiments can provide an architecture that can be resilient to hardware defects which could arise from various factors including radiation, manufacturing defects, heat, mechanical failures, external factors, among others. Once a fault or defect has been isolated, a scheduler can avoid those resources which could be equivalent to marking those defective resources down to be permanently in use with the highest priority program thus avoiding other programs or functions from accessing those defective resources.

Reconfigurable architectures in accordance with many embodiments can utilize and generate conceptual primitives and helper metadata that includes information of the current status and resource utilization of a reconfigurable architecture including anchor points and suggested origins and orientations for incoming programs to speed up the mapping of the incoming program to the reconfigurable architecture. Anchor points and/or primitives can help reduce a total number of possible permutations and combinations of placements of an incoming program, thus making reconfiguration and modification faster.

Reconfigurable architectures in accordance with many embodiments can allow users to implement larger footprint programs to be mapped onto relatively small reconfigurable architectures while increasing the supported functionality and allowing for a faster time to repurpose in new and/or commercially deployed systems.

Reconfigurable architectures in accordance with many embodiments provide for generating multiple compiled solutions of various different sizes and resource utilizations using various techniques including graph morphing and program/compute morphing.

Reconfigurable architectures in accordance with many embodiments provide for spatial multiplexing and run-time compile using an n-sided polygon abstraction, where varying degree of n can affect the speed of run-time compile and effectiveness of resource utilization.

Reconfigurable architectures in accordance with many embodiments provide for scheduling of a reconfigurable architecture in spatial, temporal and/or as spatial and temporal domain by a hardware solution for a compiler/controller/scheduler.

Reconfigurable architectures in accordance with many embodiments provide for fast loading and offloading of programs and functions, providing solutions for multiple adaptive algorithms that include data driven processing algorithms, software defined radios, data processing servers, graph computing, machine learning, 6G among other processes.

Reconfigurable architectures in accordance with many embodiments provide mechanisms of assigning priorities to programs/functions being executed on reconfigurable architecture and arbitration between them.

Reconfigurable architectures in accordance with many embodiments provide for a breakdown of a program into its functions, and using graph and compute morphing to fit a program/function onto available resources alongside other actively executing programs on a reconfigurable architecture.

Reconfigurable architectures in accordance with many embodiments provide for making a granularity of reconfiguration of a program/function independent of a granularity of reconfiguration of reconfigurable hardware independent of each other.

Reconfigurable architectures in accordance with many embodiments provide a reconfigurable hardware to be simultaneously used by multiple programs and functions in multiple ways including concurrently, simultaneously, and/or consecutively.

Reconfigurable architectures in accordance with many embodiments enable a reconfigurable hardware to be simultaneously used by multiple host devices in multiple ways including concurrently, simultaneously, and/or consecutively.

Reconfigurable architectures in accordance with many embodiments provide a mechanism of partially compiling a program/function in the software and partially in the hardware for a reconfigurable architecture.

Reconfigurable architectures in accordance with many embodiments allow for multiple loadable accelerators with easy relocations and reconfigurations.

Reconfigurable architectures in accordance with many embodiments can improve upon the abstraction of programs and functions to allow loading and unloading of new configurations similar to software modules.

Reconfigurable architectures in accordance with many embodiments can compile a program and automatically generate PR implementable solutions.

Reconfigurable architectures in accordance with many embodiments of the invention can multiplex two or more programs on a reconfigurable hardware. FIG. 1 illustrates an example of one of several way that two programs, a Program 1 and a Program 2, can be multiplexed on a reconfigurable hardware spatially and their encompassing polygons. Although FIG. 1 illustrates two programs, reconfigurable architectures in accordance with many embodiments can hold true for two or more possible programs/functions spatially multiplexed and/or concurrently mapped together. Furthermore, although FIG. 1 illustrates a configuration in the compute resources, reconfiguration in other resources including network, interconnect, and memory resources is possible appropriate to the requirements of specific applications in accordance with embodiments of the invention. Although FIG. 1 illustrates a particular configuration in compute resources, any of a variety of configuration can be utilized as appropriate to the requirements of specific applications in accordance with embodiments of the invention.

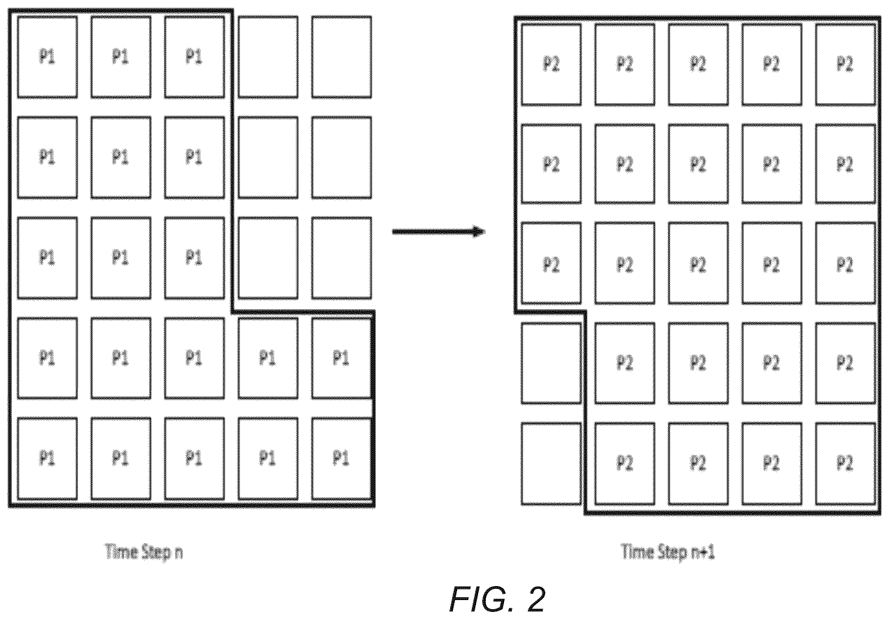

Reconfigurable architectures in accordance with many embodiments of the invention can multiplex multiple programs on a reconfigurable hardware temporally at different times. An example of one of several ways that two programs, a Program 1 and a Program 2, can be multiplexed on a reconfigurable hardware temporally and their encompassing polygons in accordance with an embodiment of the invention is illustrated in FIG. 2. As illustrated, at time step n, Program 1 is utilizing a set of resources of the reconfigurable hardware and at time step n+1, Program 2 is now utilizing a set of resources of the reconfigurable hardware. Reconfigurable architectures in accordance with many embodiments can hold true for two or more programs/functions temporally multiplexed together. The example illustrated in FIG. 2 shows the reconfiguration only in the compute resources, however some reconfiguration in network or interconnect or memory resources is also possible. Although FIG. 2 illustrates using a temporal configuration for multiplexing several programs on a reconfigurable hardware, any of a variety of configurations and parameters can be utilized as appropriate to the requirements of specific applications in accordance with embodiments of the invention.

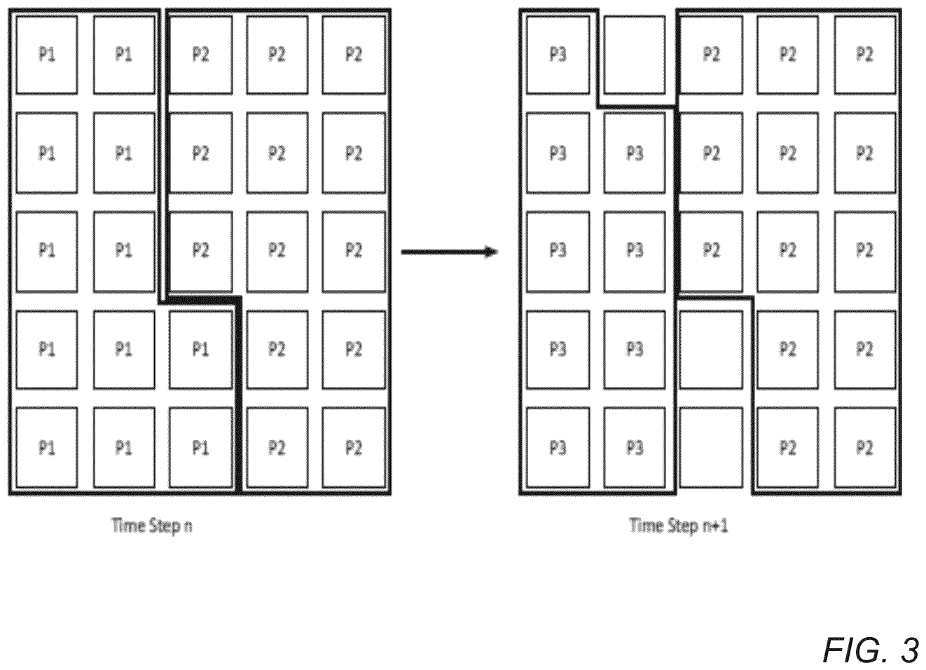

Reconfigurable architectures in accordance with many embodiments of the invention can multiplex two or more programs both spatially and/or temporally on a reconfigurable hardware. An example of one of several ways that three programs, a Program 1, a Program 2 and a Program 3, can be multiplexed on a reconfigurable hardware spatially and temporally and their encompassing polygons in accordance with an embodiment of the invention is illustrated in FIG. 3. In many embodiments, the system can be applied two or more possible programs/functions spatially and temporally multiplexed together. Furthermore, FIG. 3 illustrates a reconfiguration in the compute resources, however, some reconfiguration in network or interconnect or memory resources is also possible as appropriate to the requirements of specific applications in accordance with embodiment of the invention. As illustrated in FIG. 3, some programs stay spatially at their location, and continue to use their resources while the other programs can be moved around on other resources independently in a temporal and/or spatial fashion. In particular, at time step n, Program 1 and Program 2 are using a set of compute resources. Then at time step n+1, Program 3 and Program 2 are using a set of the compute resources. Although FIG. 3 illustrates a spatially and temporally reconfiguration of three programs, any of a variety of configurations can be utilized for any number of programs as appropriate to the requirements of specific applications in accordance with embodiments of the invention.

Reconfigurable architectures in accordance with many embodiments of the invention can use different types of transformations to allocate hardware resources to programs/functions, including affine transforms, flipping, rotations among various other types of transformations and/or combinations of transformations. An example of affine transforms and flipping, and other transformations that a scheduler can perform in accordance with an embodiment of the invention is illustrated in FIG. 4A and FIG. 4B. The transformations can include translations, affine transforms, flipping (e.g., horizontally/vertically), rotations, and/or any combination of transformations thereof. Reconfigurable architectures in accordance with many embodiments can include a scheduler that can use these techniques to hard map a soft mapping generated by a compiler to a reconfigurable architecture at run-time. Furthermore, although the example illustrated in FIGS. 4A and 4B shows the reconfiguration in the compute resources, some reconfiguration in network or interconnect and/or memory resources can be implemented as appropriate to the requirements of specific applications in accordance with embodiments of the invention. FIGS. 4A and 4B illustrate an original soft mapping, and one or more valid transformations in accordance an embodiment of the invention. In particular FIG. 4A and FIG. 4B illustrates a program 1 allocated to a set of compute resources, and the various different types of transformations that can be performed to reconfigure the allocation of resources, including shifting allocation of resources, flipping an allocation resources, rotating an allocation resources, translation, and affine transforms. Although FIGS. 4A and 4B illustrates using particular transformations for reconfiguration, any of a variety of transformations for performing mapping can be utilized as appropriate to the requirements of specific applications in accordance with embodiments of the invention.

Reconfigurable architectures in accordance with many embodiments of the invention can utilize priority to determine allocation of resources to different programs. An example demonstrating two programs of a same priority accessing a reconfigurable architecture and executing simultaneously in accordance with an embodiment of the invention is illustrated in FIG. 5. FIG. 5 illustrates two programs, Program 1 and Program 2 executing on a reconfigurable architecture because enough resources are available to accommodate both programs, with a Program 2 requesting access for reconfigurable architecture. In this case enough resources are available on reconfigurable architecture for both to be accommodated spatially. The same example can also be valid if two programs/functions of different priorities request access to the reconfigurable architecture and sufficient resources are available on the reconfigurable architecture. FIG. 5 illustrates item an example the scheduler is able to accommodate any number of programs/functions in this manner, FIG. 5 item (a) an example program, Program 1, that might be already mapped to the reconfigurable architecture and some vacant resources, FIG. 5, item (b) an incoming program, Program 2, requesting access to the reconfigurable architecture, FIG. 5 item (c) the scheduler performs an affine transform on the new incoming program, Program 2, to map it to the available resources on the reconfigurable architecture. FIG. 5 item (d) illustrates the two example programs successfully mapped to the reconfigurable architecture. Although the examples illustrated in FIG. 5 show the reconfiguration in the compute resources, reconfiguration in network or interconnect or memory resources is also possible as appropriate to the requirements of specific applications in accordance with embodiments of the invention Although FIG. 5 illustrates an example of particular configuration based on priority, any of a variety of parameters for reconfiguration can be utilized as appropriate to the requirements of specific applications in accordance with embodiments of the invention.

Reconfigurable architectures in accordance with many embodiments of the invention can use priority and a multi-size compile techniques to allocate resources to two or more programs when insufficient hardware resources are available to accommodate all the programs, thus certain programs may be allocated a reduced set of resources on the reconfigurable architecture. An example demonstrating a situation where two programs of a same priority try to access a reconfigurable architecture and execute simultaneously and not enough resources are available to accommodate a new incoming program in accordance with an embodiment of the invention is illustrated in FIG. 6. FIG. 6 illustrates a first program, Program 1, executing on the reconfigurable architecture and a second program, Program 2, requesting access for reconfigurable architecture. In the example in FIG. 6, enough resources are not available on the reconfigurable architecture for both Program 1 and Program 2 to be accommodated spatially, so one of the programs gets reduced resources on reconfigurable architecture, as enabled using multi-size compile techniques. As illustrated in FIG. 6, Item (a) shows an example first program, Program 1, that is already mapped on to the reconfigurable architecture and is executing. FIG. 6, Item (b) shows an example second program, Program 2, requesting access. FIG. 6, Item (c) shows a reduced size Program 2 enabled by the multi-size compile technique. FIG. 6, Item (d) shows an affine transform applied by the scheduler on Program 2 to fit the program on the available resources. FIG. 6, Item (e) shows an example of Program 1 and Program 2 executing together spatially on the reconfigurable architecture. Although FIG. 6 illustrates using priority and reduced resources for a particular configuration, any of a variety of parameters for configurations can be utilized as appropriate to the requirements of specific applications in accordance with embodiments of the invention.

Reconfigurable architectures in accordance with many embodiments of the invention can use priority and allocate reduced resources to lower priority programs in determining an allocation of resources to multiple programs. An example demonstrating a situation where two programs of different priorities try to access a reconfigurable architecture and execute simultaneously and not enough resources are available to accommodate a new incoming program and thus using priority to determine allocation of resources in accordance with an embodiment of the invention is illustrated in FIG. 7. The example shows a program, Program 1, executing on the reconfigurable architecture and a second program, program 2, requesting access for reconfigurable architecture. In this case enough resources are not available on reconfigurable architecture for both to be accommodated spatially, so the program with the lowest priority may get reduced resources on the reconfigurable architecture enabled by multi-size compile techniques. FIG. 7 illustrates that a scheduler can be able to accommodate any number of programs/functions in this manner. As illustrated in FIG. 7, item (a) illustrates a first program, Program 1, currently executing on the reconfigurable architecture. FIG. 7 item (b) illustrates a second program, Program 2, requesting access for execution on the reconfigurable architecture. Program 2 also has a higher priority program than Program 1.

FIG. 7, Item (c) illustrates Program 2 getting its requested resources on the reconfigurable architecture with Program 1 evicted to adjust its resource allocation for spatial co-mapping. FIG. 7, Item (d) illustrates a reduced size version of Program 1, which a scheduler could map on to the reconfigurable architecture enabled by the multi-size compile techniques. FIG. 7, Item (e) illustrates a reduced size version of Program 1 affine transformed by a scheduler which could be potentially mapped on the vacant resources of the reconfigurable architecture. FIG. 7, Item (f) illustrates a reduced size Program 1 and a full size Program 2 co-mapped and co-executing spatially on reconfigurable architecture. Although the example illustrated in FIG. 7 illustrates a reconfiguration in the compute resources, reconfiguration in network, interconnect, memory among various other resources can be implemented as appropriate to the requirements of specific applications in accordance with embodiments of the invention. Furthermore, although FIG. 7 illustrates using priorities for reconfiguration, any of a variety of parameters can be utilized as appropriate to the requirements of specific applications in accordance with embodiments of the invention.

Reconfigurable architectures in accordance with many embodiments of the invention can use priority and eviction to allocate resources to multiple programs and/or functions. Eviction can be based on a variety of factors, including time to execute, start time of a program, among various other factors. An example in which all of the programs being executed on a reconfigurable architecture have a same priority and cannot be reduced further in their resource use on reconfigurable architecture in accordance with an embodiment of the invention is illustrated in FIG. 8. As illustrated in FIG. 8, one of the programs can be evicted, the decision for which program to evict can be based on a variety of design choices, including of the time to execute, the start time of the program, random choice among others. Furthermore, FIG. 8 illustrates an incoming program being put on the temporal schedule.

In particular, FIG. 8, Item (a) shows an example set of programs, program 1, program 2, program 3, and program 4, executing and mapped onto resources on reconfigurable architecture. FIG. 8, Item (b) shows an example of soft mapping of a new program, Program 5, which is requesting access to reconfigurable architecture. FIG. 8, Item (c) shows an example of how a scheduler performed an affine transform and flipped program 5 vertically. FIG. 8, Item (d) shows an example of how the transformed incoming Program 5 was mapped on to the reconfigurable architecture and an example existing program, Program 4 was evicted and added into the temporal routine, and waiting list. FIG. 8, Item (e) shows an example of how program 4 can be modified, in particular Program 4 has been rotated and translated, so that its used resources can fit into the resources currently being used by Program 2, so that in next temporal re-arrangement time slot, Program 4 can replace Program 2 on the reconfigurable architecture. FIG. 8, Item (f) shows an example of how in a temporal routine a program currently in the waiting list, and/or temporal routine can replace a program currently being executed on the reconfigurable architecture. In particular, FIG. 8 item (f) illustrates that Program 2 has now been evicted and added to the temporal routine and could be used for replacing some other program in the next re-arrangement time slot. Although FIG. 8 illustrates using priority and resource availability for a particular reconfiguration, any of a variety of parameters and resource considerations for reconfigurations can be utilized as appropriate to the requirements of specific applications in accordance with embodiments of the invention.

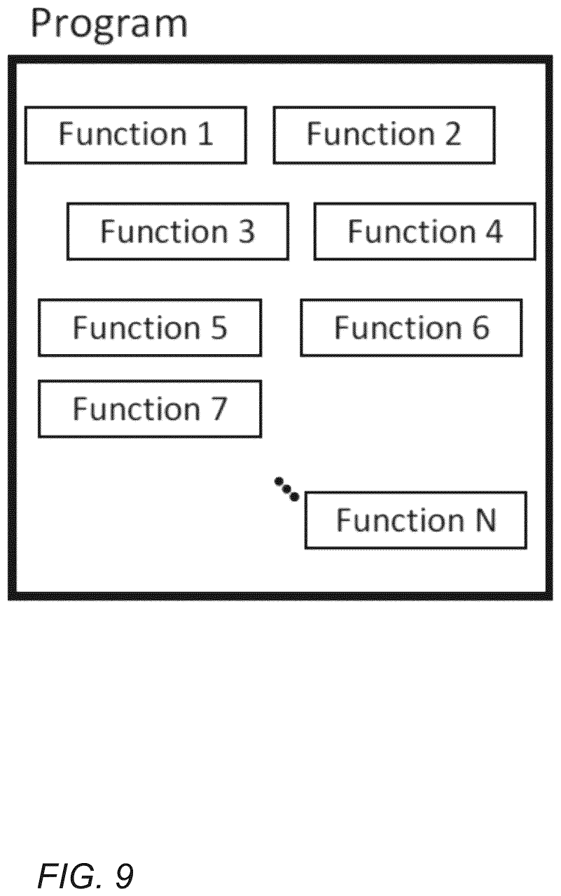

Reconfigurable architectures in accordance with many embodiments of the invention can allocate reconfigurable resources to programs and/or functions. In particular, a program can be defined as a set of functions executing simultaneously or consecutively in some order. An example of using programs and functions for reconfiguration in accordance with an embodiment of the invention is illustrated in FIG. 9. As illustrated, a program “Program” includes several functions, “Function 1”, “Function 2” . . . “Function N”. Although FIG. 9 illustrates a particular relationship between programs and functions, any of a variety relationships between programs and functions executing in different compute environments with different types of programming languages can be utilized as appropriate to the requirements of specific applications in accordance with embodiments of the invention.

Reconfigurable architectures in accordance with many embodiments of the invention can break down a large program into its constituent functions for mapping to a reconfigurable architecture. An example of a large program broken down into its constituent functions to be able to map successfully to the reconfigurable architecture either temporally or spatially in accordance with an embodiment of the invention is illustrate in FIG. 10A and FIG. 10B.

FIG. 10A and FIG. 10B illustrate P1: Program 1, F1: Function 1, F2: Function 2, F3: Function 3, F4: Function 4, F5: Function 5, F6: Function 6, F7: Function 7. As illustrated in FIG. 10A, items (a) shows an example of large program which is larger than the total resources provided by the reconfigurable architecture. FIG. 10A, Item (b) shows an example of how a large program, can be broken down into a set of functions, including F1, F2, F3, F4, F5, F6 and F7 and the corresponding polygons for resource allocation as an example. As illustrated in FIG. 10B, item (c) shows an example program currently being executed on the reconfigurable architecture at the time when the incoming large program from FIG. 10A item (b) made request to reconfigurable architecture. Item (d) shows an example of how some set of functions, in particular F1 and F2, from the large program can be modified, translated, flipped and spatially mapped along with some other program/programs, program 1 in this example. FIG. 10B, Item (e) shows an example of temporal routine, where functions F1 and F22 from the large program have been replaced by functions F3, F4 and F5, which were modified, translated, flipped and/or spatially mapped along with some other program/programs, program 1 in this example, while program 1 keeps executing independently. FIG. 10B, Item (f) shows an example of a temporal routine, where functions F3, F4 and F5 from the large program have been replaced by functions F6, and F7, which were modified, translated, flipped and/or spatially mapped along with some other program/programs, program 1 in this example, while the program 1 keeps executing independently. Accordingly, FIG. 10A and FIG. 10B show an example of how a function from one program co-executing spatially along with other programs on a reconfigurable architecture. In many embodiments of the reconfigurable architecture, a reduced sized version of a program can be co-mapped on a reconfigurable architecture along with other programs. FIG. 10A and FIG. 10B illustrate a reduced size version is a function from Program 1 temporally multiplexed with other functions from Program 1. As readily apparent, there are infinite possibilities, this example is provided to illustrate a conceptual abstract representation of the vision for a multi-program, multi-function reconfigurable architecture enabled by a scheduler and multi-size compile techniques. Although FIG. 10 illustrates breaking down a large program into constituent functions for a particular configuration, any of a variety of breakdown techniques can be utilized as appropriate to the requirements of specific applications in accordance with embodiments of the invention.

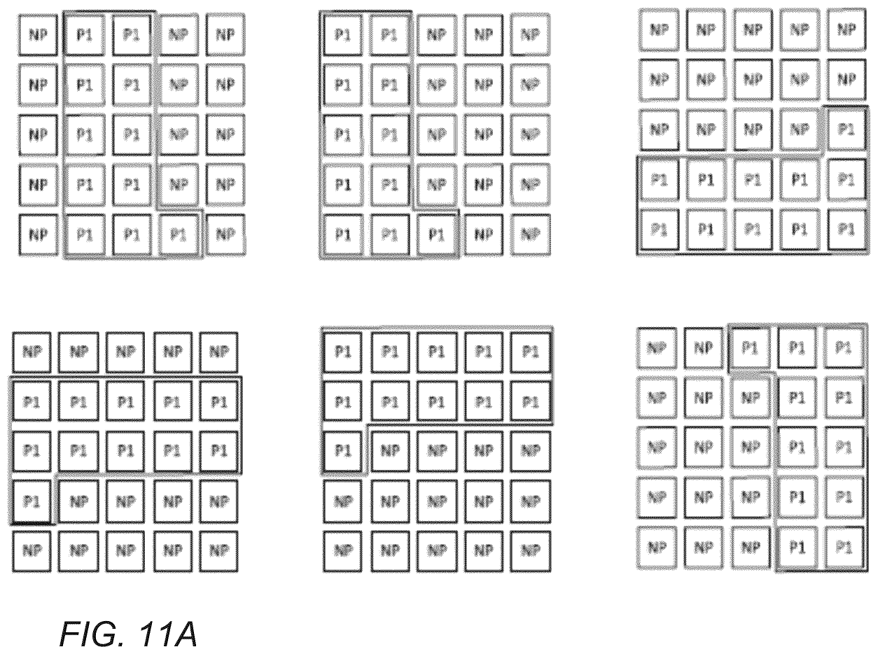

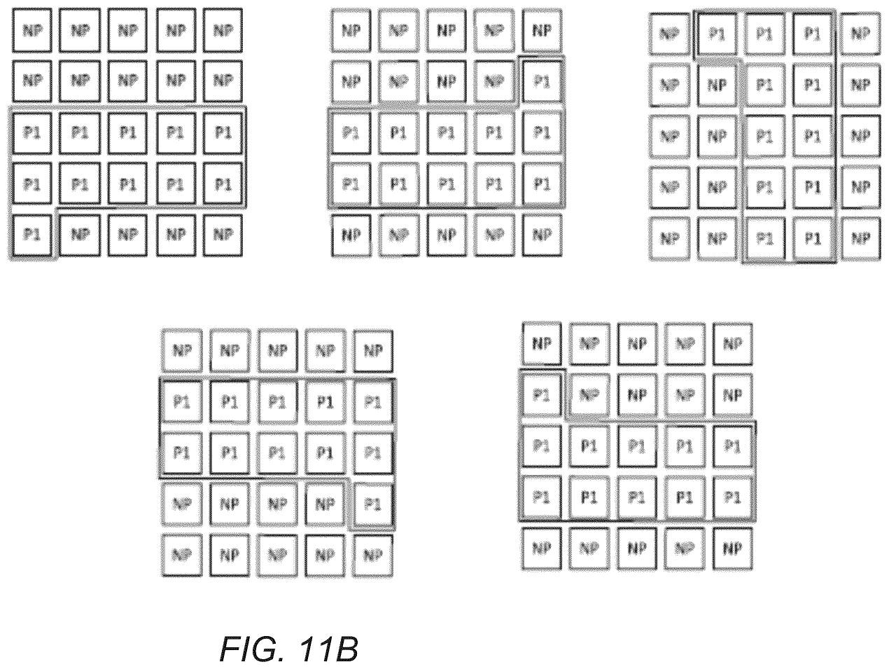

Reconfigurable architectures in accordance with many embodiments of the invention can randomize a physical location of programs and/or functions to secure hardware for security and cybersecurity applications. An example reconfigurable architecture with randomized physical location resource allocation for security and/or cybersecurity applications in accordance with an embodiment of the invention is illustrated in FIG. 11A and FIG. 11B. Reconfigurable architectures in accordance with many embodiments can randomize the physical location of the program/function on the reconfigurable architecture and execute another power noisy program along with it, thus potentially adding an extra layer of security and securing the hardware from power virus attacks and/or side channel attacks. In particular, FIG. 11A and FIG. 11B illustrate a noise program, NP and a first program, P1. As illustrated, the program P1 and the noise program NP are configured to various different randomized allocations of the hardware resources, including using various different types of transformations as described herein. Accordingly, randomized allocations can help secure the hardware from power virus attacks and/or side channel attacks, among various other types of potential security issues. Although FIGS. 11A and 11B illustrates using a particular set of randomization for a particular configuration, any of a variety of randomization techniques for particular reconfigurations can be utilized as appropriate to the requirements of specific applications in accordance with embodiments of the invention.

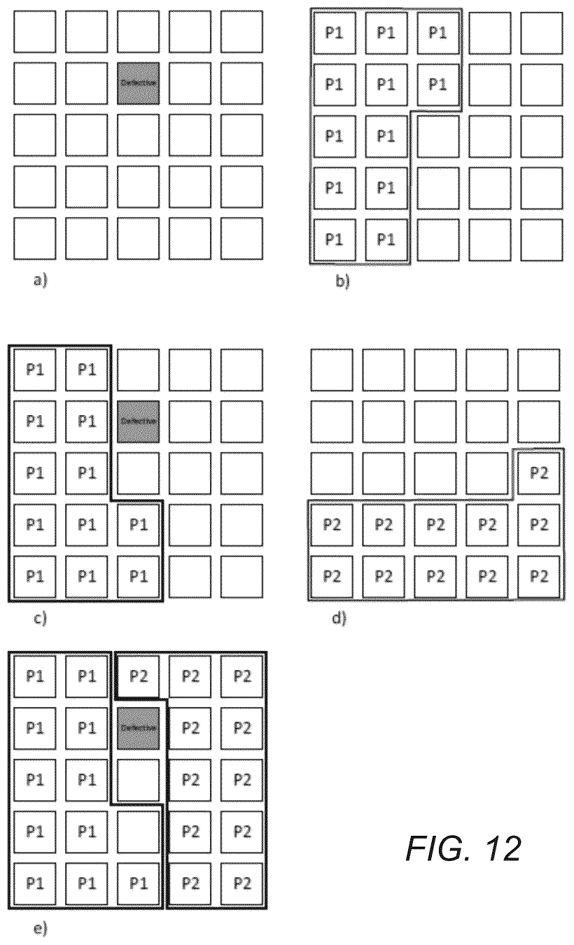

Reconfigurable architectures in accordance with many embodiments of the invention can include a scheduler that enables a defect resilient program and/or function execution on a reconfigurable hardware, whereby the scheduler can avoid mapping programs and/or functions to defective resources. An example of a scheduler enabling a defect resilient program/function execution on a reconfigurable architecture in accordance with an embodiment of the invention is illustrated in FIG. 12. The scheduler can avoid mapping any programs/functions to the defective resource thus potentially executing them in an almost normal, defect-free hardware manner. FIG. 12 illustrates a defective resource, Defective Processing Element, a first program, P1: Program 1, and a second program, P2: Program 2. FIG. 12, item (a) shows an example of reconfigurable hardware having a defect, defective resource. FIG. 12, item (b) shows an example soft mapped program, program P1, requesting hardware for reconfigurable architecture access from the scheduler. FIG. 12, item (c) demonstrate an example of one of multiple ways that the scheduler modified the incoming program, P1 and remapped it to avoid the defective resource, “Defective”. FIG. 12, item (d) demonstrates an example of another incoming program, P2, requesting hardware for reconfigurable architecture access from the scheduler. FIG. 12, item (e) demonstrates an example of one of multiple ways that the scheduler modified the incoming program, P2, to accommodate the existing program/programs (e.g., P1) and remapped it to avoid the defective resource “Defective”. Although FIG. 12 illustrates taking into consideration defective resources for a particular reconfiguration, any of a variety of considerations can be utilized as appropriate to the requirements of specific applications in accordance with embodiments of the invention.

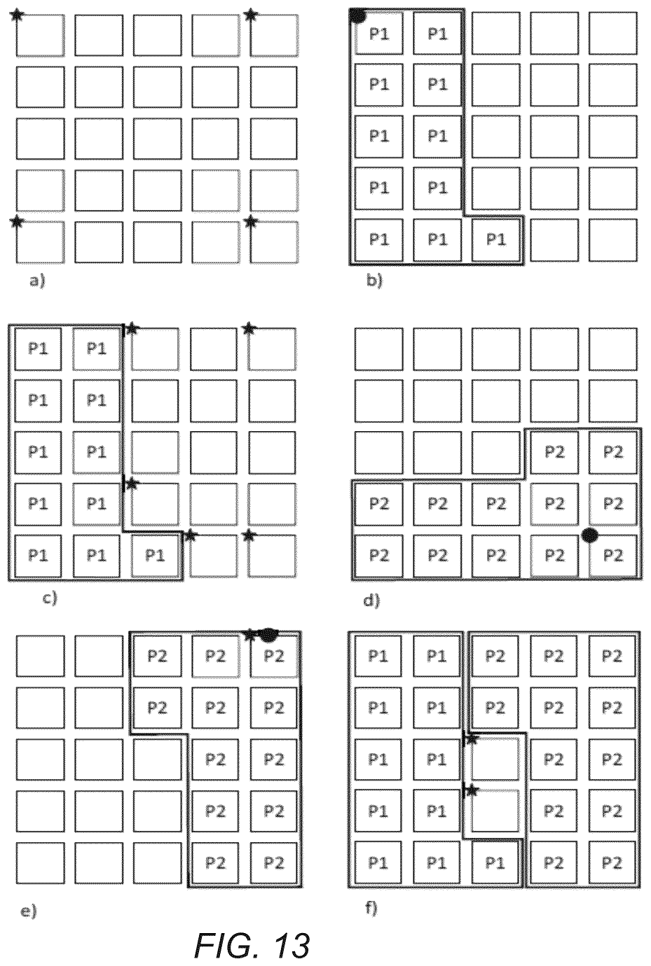

Reconfigurable architectures in accordance with many embodiments of the invention can include a scheduler that can generate and use reconfigurable architecture resource utilization descriptive features, including a set of anchor points, to speed up mapping of an incoming program onto available resources of a reconfigurable architecture. An example of a scheduler of a reconfigurable architecture generating and using reconfigurable architecture resource utilization descriptive features including a set of anchor points to speed up the process of mapping an incoming program on to available resources on a reconfigurable architecture in accordance with an embodiment of the invention is illustrated in FIG. 13. FIG. 13, item (a) shows an empty reconfigurable architecture, with nothing currently mapped on to it. The anchor points in this case lie on the corners/edges of the reconfigurable architecture. FIG. 13, item (b) of shows an example soft mapping of a program, program P1, with some descriptive features, here in this case, an origin of the polygon. FIG. 13, item (c) shows an example a scheduler using anchor points of the current state of the reconfigurable architecture and the origin of the incoming program, P1, polygon to map the program to the reconfigurable architecture. FIG. 13, item (c) also illustrates the scheduler refreshed the metadata of the current state of reconfigurable architecture for newly generated anchor points. FIG. 13, item (d) shows an example soft mapping of a program, program 2, with some descriptive features, here in this case, an origin of the polygon. FIG. 13, item (e) shows an example of a scheduler modifying the incoming program, P2, and polygon using affine transforms, flipping among various other transformation described herein, and using the anchor points and other metadata that it generated representing the current state of reconfigurable architecture. FIG. 13, item (f) shows an example the scheduler utilizing metadata regarding resource availability on the reconfigurable architecture to map the programs, P1 and P2, in a faster way. Although FIG. 13 illustrates a scheduler using resource utilization descriptive features including a set of anchor points for particular configuration, any of a variety of features can be utilized as appropriate to the requirements of specific applications in accordance with embodiments of the invention.

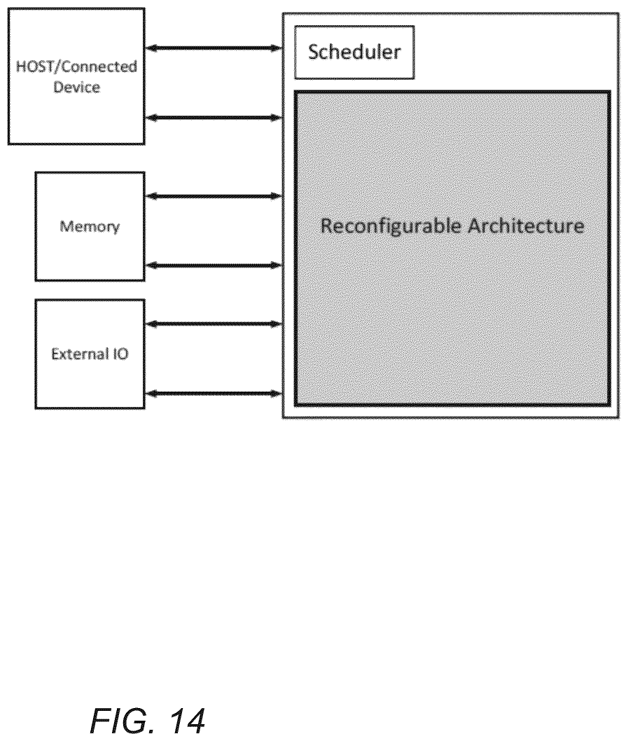

Reconfigurable architecture systems in accordance with many embodiments of the invention can include a scheduler and a reconfigurable architecture communicating with a host/connected device, memory, and/or an external IO. A hardware architecture of a scheduler and reconfigurable architecture system in accordance with an embodiment of the system. In particular, the architecture can include a reconfigurable architecture that includes a scheduler communicating with a host/connected device, memory, and an external input/output interface (IO). Although FIG. 14 illustrates a particular system architecture for a reconfigurable architecture, any of a variety of configurations can be utilized as appropriate to the requirements of specific applications in accordance with embodiments of the invention.

Although specific implementations for reconfigurable architectures are discussed above with respect to FIGS. 1-14, any of a variety of implementations utilizing the above discussed techniques can be utilized for reconfigurable architectures in accordance with embodiments of the invention. While the above description contains many specific embodiments of the invention, these should not be construed as limitations on the scope of the invention, but rather as an example of one embodiment thereof. It is therefore to be understood that the present invention may be practice otherwise than specifically described, without departing from the scope and spirit of the present invention. Thus, embodiments of the present invention should be considered in all respects as illustrative and not restrictive.

What is claimed is:

1. A compiler system for reconfiguration of compute resources, comprising:
a scheduler; and
a reconfigurable architecture array comprising a plurality of hardware resources; wherein the schedular dynamically reconfigures the reconfigurable architecture array by:
determining a plurality of programs comprising a first program and a second program that require execution on the reconfigurable architecture array at a particular time n, wherein each program comprises a plurality of functions;
determining hardware resources required by the first program and the second program; and
allocate a set of functions from the plurality of functions of the first program and the second program to different hardware resources from the plurality of hardware resources of the reconfigurable architecture array based on the determined hardware resources required by the first program and the second program.

2. The compiler system of claim 1, further comprising:
using at least one transformation to allocate the set of functions to the different of hardware resources of the plurality of hardware resources of the reconfigurable architecture array.

3. The compiler system of claim 1, wherein the at least one transformation is a transformation selected from the group consisting of a translation, an affine transform, a vertical flip, a horizontal flip, and a rotation.

4. The compiler system of claim 1, further comprising:
determining that there is sufficient available hardware resources from the plurality of hardware resources of the reconfigurable architecture array to accommodate the first program and the second program; and
allocating the first program and the second program on the reconfigurable architecture array.

5. The compiler system of claim 1, further comprising:
determining that there is insufficient available resources from the plurality of resources of the reconfigurable architecture array to accommodate the first program and the second program; and
allocating the entire first program and a reduced subset of functions from the plurality of functions of the second program on the reconfigurable architecture array.

6. The compiler system of claim 1, further comprising:
determining that a third program requires execution on the reconfigurable architecture array;
determining that there is insufficient available resources from the plurality of resources of the reconfigurable architecture array to accommodate the first program, the second program, and the third program; and
evicting at least one program from the plurality of programs from the reconfigurable architecture array.

7. The compiler system of claim 6, further comprising:
placing the evicted at least one program on a temporal waitlist; and
reallocating the evicted at least one program to the reconfigurable architecture array at a later time period n+1.

8. The compiler system of claim 1, further comprising:
determining a priority of each of the plurality of programs; and
allocating hardware resources of the reconfigurable architecture array to the plurality of programs based on the priority.

9. The compiler system of claim 1, further comprising:
randomizing physical locations of the set of functions on the reconfigurable architecture array; and
executing a power noisy program (NP) on the reconfigurable architecture array.

10. The compiler system of claim 1, further comprising:
detecting a defective hardware resource from the plurality of hardware resources of the reconfigurable architecture array; and
allocate the set of functions from the plurality of functions of the first program and the second program to different hardware resources that avoids the defective hardware resource of the reconfigurable architecture array.

11. The compiler system of claim 1, further comprising virtualizing hardware resources of the reconfigurable architecture array over a plurality of programs and a plurality of functions.

12. A method of virtualizing hardware resources of a reconfigurable architecture array over several programs, the method comprising:
determining, using a scheduler that dynamically reconfigures a reconfigurable architecture array, a plurality of programs comprising a first program and a second program that require execution on the reconfigurable architecture array at a particular time n, wherein each program comprises a plurality of functions, and wherein the reconfigurable architecture array comprises a plurality of hardware resources;
determining hardware resources required by the first program and the second program; and
allocate a set of functions from the plurality of functions of the first program and the second program to different hardware resources from the plurality of hardware resources of the reconfigurable architecture array based on the determined hardware resources required by the first program and the second program.

13. The method claim 12, further comprising:
using at least one transformation to allocate the set of functions to the different of hardware resources of the plurality of hardware resources of the reconfigurable architecture array.

14. The method of claim 12, wherein the at least one transformation is a transformation selected from the group consisting of a translation, an affine transform, a vertical flip, a horizontal flip, and a rotation.

15. The method of claim 12, further comprising:
determining that there is sufficient available hardware resources from the plurality of hardware resources of the reconfigurable architecture array to accommodate the first program and the second program; and
allocating the first program and the second program on the reconfigurable architecture array.

16. The method claim 12, further comprising:
determining that there is insufficient available resources from the plurality of resources of the reconfigurable architecture array to accommodate the first program and the second program; and
allocating the entire first program and a reduced subset of functions from the plurality of functions of the second program on the reconfigurable architecture array.

17. The method of claim 12, further comprising:
determining that a third program requires execution on the reconfigurable architecture array;
determining that there is insufficient available resources from the plurality of resources of the reconfigurable architecture array to accommodate the first program, the second program, and the third program; and
evicting at least one program from the plurality of programs from the reconfigurable architecture array.

18. The method of claim 17, further comprising:
placing the evicted at least one program on a temporal waitlist; and
reallocating the evicted at least one program to the reconfigurable architecture array at a later time period n+1.

19. The method of claim 12, further comprising:
determining a priority of each of the plurality of programs; and
allocating hardware resources of the reconfigurable architecture array to the plurality of programs based on the priority.

20. The method of claim 12, further comprising:
randomizing physical locations of the set of functions on the reconfigurable architecture array; and
executing a power noisy program (NP) on the reconfigurable architecture array.
